(19) United States
(12) Patent Application Publication
(10) Pub. No.: US 2025/0022053 A1
(43) Pub. Date: Jan. 16, 2025

(54) SYSTEMS AND METHODS FOR CROSS-PLATFORM BATCH DATA PROCESSING

(71) Applicant: Experian Information Solutions, Inc., Costa Mesa, CA (US)

(72) Inventors: Don Lennert, Plano, TX (US); William Maynard, Powder Springs, GA (US); Vijay Mehta, Newport Beach, CA (US); Thomas Huss, Westfield, IN (US)

(21) Appl. No.: 18/618,269

(22) Filed: Mar. 27, 2024

Related U.S. Application Data
(63) Continuation of application No. 17/102,847, filed on Nov. 24, 2020, now abandoned.
Application No. 17/102,847 is a continuation of application No. 15/397,583, filed on Jan. 3, 2017, now abandoned.

(51) Int. Cl. G06Q 40/03; G06F 9/46; G06F 16/18; G06Q 40/02

(52) U.S. Cl. CPC G06Q 40/03; G06F 9/466; G06F 16/1865; G06Q 40/02

(57) ABSTRACT

Systems and methods for providing and executing a data processing tool are disclosed. The data processing tool may include an attribute processing agent which may be embedded in a database system. The attribute processing agent can receive input data and a custom-made attribute as an input and process the input data in accordance with the custom-made attribute. In some embodiments, there may be multiple attribute processing agents distributed in multiple computing nodes. Each attribute processing agent may be configured to process a portion of a data set based on the storage location of the portion of the data set.

### INCORPORATION BY REFERENCE TO ANY PRIORITY APPLICATIONS

This application is a continuation of U.S. patent application Ser. No. 17/102,847, filed Nov. 24, 2020, entitled “SYSTEMS AND METHODS FOR CROSS-PLATFORM BATCH DATA PROCESSING” which is a continuation of U.S. patent application Ser. No. 15/397,583 filed Jan. 3, 2017, entitled “SYSTEMS AND METHODS FOR CROSS-PLATFORM BATCH DATA PROCESSING,” the entire contents of which are hereby incorporated by reference in its entirety herein and should be considered a part of this application. Any and all applications for which a foreign or domestic priority claim is identified in the Application Data Sheet as filed with the present application are hereby incorporated by reference under 37 CFR 1.57.

### FIELD OF THE DISCLOSURE

The present disclosure generally relates to a database tool for batch data processing.

### BACKGROUND OF THE DISCLOSURE

A large variety of public records and privately developed databases can be utilized to perform various data analysis regarding a person or an entity. The extensive amount of raw data available for any given person or entity makes the task of data analysis regarding the person or entity very difficult. Accordingly, such raw data is frequently processed to facilitate more convenient and rapid analysis and decision. The data analysis and decision are even more complex when considering multiple persons or entities simultaneously, since raw data from multiple sources about each of the individuals may need to be evaluated.

### BRIEF DESCRIPTION OF THE DRAWINGS

FIG. 1 illustrates an example computing environment of a data analysis system.

FIGS. 2A and 2B illustrate example communications between a client system and a data analysis system.

FIG. 3 illustrates an example of analyzing data using one or more attributes.

FIG. 4 illustrates an example of parallel data processing by a plurality of attribute processing agents.

FIG. 5 illustrates an example of an attribute processing agent.

FIG. 6 is a flow diagram depicting an illustrative method of batch processing input data based on a set of attributes.

FIG. 7 is a flow diagram depicting an illustrative method of batch processing custom-made attributes in distributed computer architecture.

FIG. 8 illustrates a general architecture of a computing system for processing attributes and implementing various other aspects of the present disclosure.

Throughout the drawings, reference numbers may be re-used to indicate correspondence between referenced elements. The drawings are provided to illustrate example embodiments described herein and are not intended to limit the scope of the disclosure.

### DETAILED DESCRIPTION OF VARIOUS EMBODIMENTS

### Overview

There exists significant interest in analyzing information associated with a person or an entity. Oftentimes, data analysis may use data from multiple sources. For example, credit reporting agencies (CRAs) collect and maintain information on a person's individual credit history. This information can include a total credit line on one or more accounts, current credit balance, credit ratios, satisfactorily paid accounts, any late payments or delinquencies, depth of credit history, total outstanding credit balance, and/or records of recent and/or historical inquiries into the person's credit. Governmental motor vehicle agencies generally maintain records of any vehicle code violations by a person as well as histories of reported accidents. Courts will generally maintain records of pending or disposed cases associated with a person, such as small claims filings, bankruptcy filings, and/or any criminal charges. Similar information also exists for large and small businesses, such as length of the business's existence, reported income, profits, outstanding accounts receivable, payment history, market share, and so forth.

These raw data may be processed for evaluating risks or making decisions (such as whether to approve a transaction). Attributes can be used to calculate various types of metrics for evaluating risks and decisions, and in many instances the attributes may be used on their own to the business decisions. Attributes can be aggregated to target various aspects of credit histories, bankruptcy data, and other types of non-credit-based data. An attribute may include a database query or computer code encoding one or more metrics for analyzing the data set, in combination or the like. For example, a simple metric could be “consumers who have opened a new credit line in the last 12 months.” The attribute encoding this metric may include, depending on the embodiment, a function call with associated parameters or input values (such as a numeric value representing 12 months), a filter to be applied to a set of consumer records, and/or a database query for consumer records matching certain value ranges for fields identified in the attribute. The results of the attribute processing (which may include executing the associated computer code or database query, potentially in combination with other code that is called by or referred to in the attribute) would be a set of consumers who meets both the criteria of having opened a new credit line and having done so in the last 12months. In some embodiments, the attributes may be written in a high level language or format that is not specific to any single deployment environment or tied to any specific underlying database format. Attributes can be standardized attributes such as standard aggregation (STAGG) attributes created by a credit bureau or other consumer data analysis service, custom-made attributes created by a client (such as attributes created by a financial institution), or both. Examples of managing and creating attributes are described in U.S. Pat. No. 8,606,666, entitled “System and Method for Providing an Aggregation Tool,” the disclosure of which is hereby incorporated by reference herein in its entirety.

An entity performing the data analysis can gather data from multiple sources and analyze the data based on the attributes. For example, the credit bureau can code an attribute as one or more database queries. The credit bureau can retrieve data from multiple financial institutions or public records database using the queries. However, data stored in each database may have its own format. Accordingly, in order to process data from multiple sources, the entity may need to convert the data format for one or more data sources and store the converted data in a single location as input for batch processing based on one or more attributes. Batch processing for multiple individuals or transactions further exacerbates this problem because the data files may have large file sizes and the format conversion alone may take a long time to process.

In addition, to process custom-made attributes generated by a client, a software developer at the entity performing the data analysis may need to hand code the custom-made attributes into one or more database queries because the attributes may be coded in a different programming language than the programming language used for the production environment. For example, attributes may be coded using Lua, while the data processing system or the production environment (such as one or more website components) may execute in a Java environment. Furthermore, a client may change the custom-made attributes periodically, and therefore, the coded attributes may also need to be constantly updated by the software developer which may cause delay for the deployment of the custom-made attributes.

The present disclosure provides a data processing tool directed to solve these problems. The data processing tool may include an attribute processing agent. The attribute processing agent may be incorporated as part of a database system where the data to be processed resides and, therefore, may reduce the need to convert the format of the data and/or transfer large amounts of data during batch processing. Additionally, the attribute processing agent can directly invoke the custom-made attributes or compile the custom-made attributes into java bytecode (or other language, script or code type used within the given system) at run-time, and thereby eliminate the need of recoding the attributes. This reduces the burden for incorporating the attributes processing with the production environment where they use different programming environments.

### Example Computing Environment of a Data Analysis System

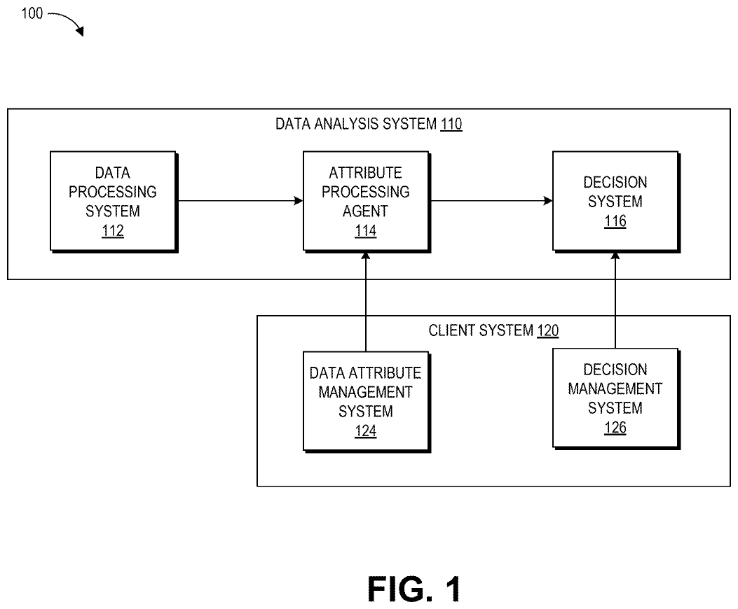

FIG. 1 illustrates an example computing environment of a data analysis system. In the computing environment 100, the data analysis system 110 may be in communication with a client system 120. The data analysis system 110 may be located within the same computing environment as the data being processed by the data analysis system 110. For examples, one or more components of the data analysis system 110 may be embedded in the same computing system as the data store that stores the data to be processed, or embedded within a database system itself. In some embodiments, the data analysis system 110 may be associated with an entity such as a credit bureau and the client system 120 may be associated with another entity, such as a financial institution, that is a client of the credit bureau (e.g., the client may contract with the credit bureau to obtain attribute development tools). In other embodiments, both systems may be associated with a single entity such as a financial institution or a credit bureau. To simplify discussion and not to limit the present disclosure, FIG. 1 illustrates only one data analysis system 110 and one client system 120, though multiple systems may be used. Additionally, although a data analysis system 110 is illustrated to include one data processing system 112, one attribute processing agent 114, and a one decision system 116, the data analysis system 110 is not limited to having only one of each system or component.

The data analysis system 110 can receive custom data attributes created by the data attribute management system 124 and analyze the data (such as, for example, consumer's credit data) in accordance with the data attributes (which may be customized by the client system 120 or may be standardized). The data analysis system 120 can also receive, from the decision management system 126, one or more rules (also referred to as strategies) related to generating a decision on a transaction such as, for example, whether to decline or approve a transaction, or generate an alert such as, for example, whether a transaction is fraudulent, based on the rules. Details on the data analysis system 110 and the client system 120 are described below.

### Example Data Analysis System

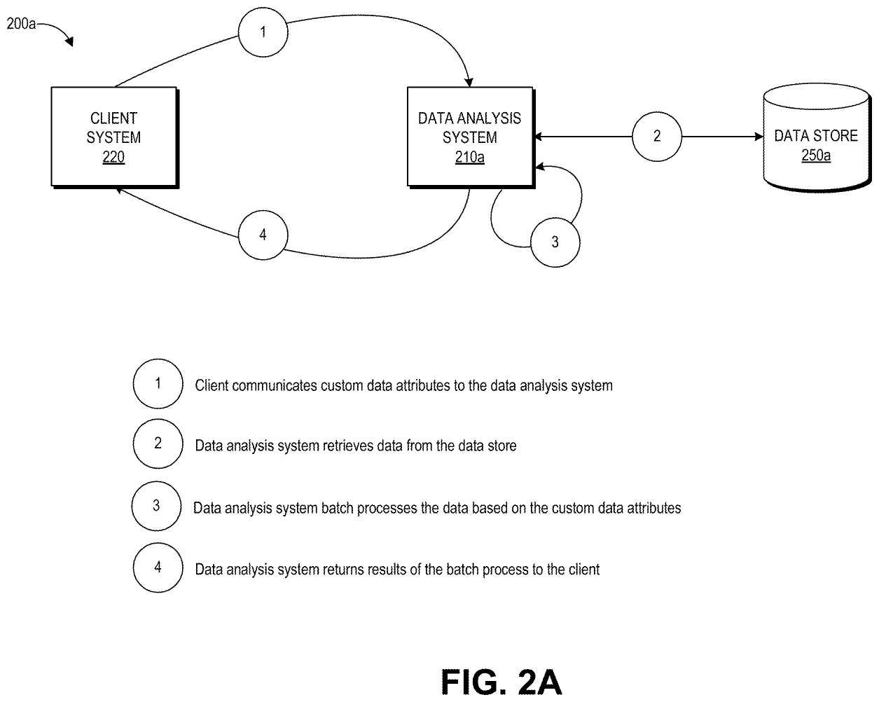

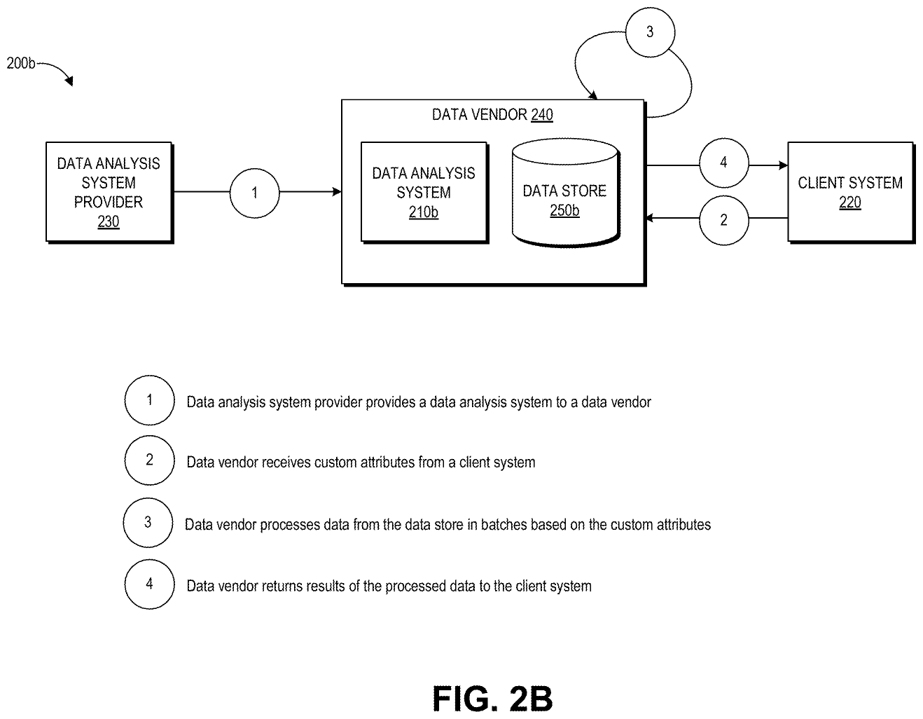

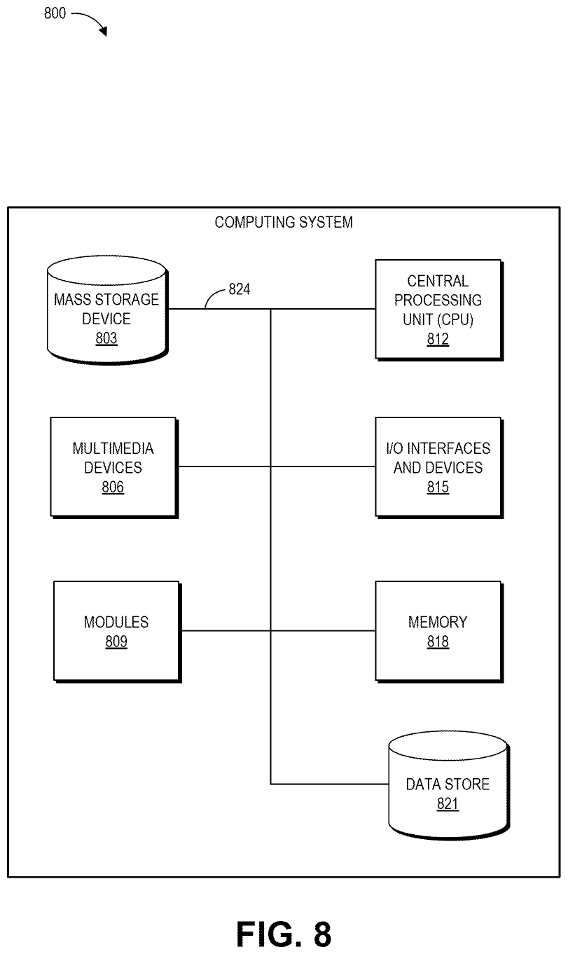

The data analysis system 110 can process and analyze data (such as credit data) in batches and generate decisions in batches. The data analysis system 110 may include components similar to those of computing system 800, which is illustrated in FIG. 8 and will be described below. The data analysis system 110 may be used by a data vendor such as a credit bureau, a financial institution, or other data vendors for processing consumers' or entities' financial data. As will be further described with reference to FIGS. 2A and 2B, the data analysis system 110 may be integrated with a database on the data vendor's side.

The data analysis system 110 can include a data processing system 112, an attribute processing agent 114, and a decision system 116. The systems of the data analysis system 110 may reside in the same computing environment or be distributed across multiple computing environments. For example, the attribute processing agent 114 may be located where the data to be processed is stored, while the data processing system 112 and/or the decision system 116 may be located at a different computing environment instead of where the data is stored. Although not illustrated in FIG. 1, more or fewer systems may be part of the data analysis system 110. For example, there may be multiple attribute processing agents each being specialized to process a certain set of custom-made attributes or each being associated with a different client system. There may also be multiple decision systems which are configured to making different types of decisions. One or more of these systems may be used in connection with each other. For example, the data may be processed by more than one attribute processing agent or more than one decision system. In some embodiments, one or more systems in the data analysis system 110 may be part of the same system. For example, the data processing system 112 may be part of the attribute processing agent 114. The decision system 116 may also be part of the attribute processing agent 114.

The data processing system 112 of the data analysis system 110 can receive data from various data sources. For example, the data processing system 112 can receive credit data from a credit bureau. The data processing system 112 can also periodically (such as, for example, daily, weekly, monthly, and so on) receive updates on the credit data. The data processing system 112 can initiate storage of the credit data to a data store. In some embodiments, the data processing system 112 can consolidate data from various sources by consolidating data that describe the same event (such as for example, the same transaction). These embodiments can reduce inconsistencies among credit data from multiple data sources, and thereby increase the efficiencies of data processing by the attribute processing agent 114.

The data processing system 112 can also receive a request for batch processing a set of credit data. The request may come from a data vendor. In some embodiments, the request can come from the client system 120. The data processing system 112 can parse the requests and retrieve the set of credit data (for example, from one or more credit bureaus). The data processing system 112 can communicate the request together with the retrieved data to the attribute processing agent 114. In some implementations, the request may include an indication to batch process the credit data using one or more custom-made attributes (such as the attributes configured by the client system 120). The data processing system 112 can pass the custom-made attributes or an instruction to retrieve the custom-made attributes to the attribute processing agent 114. For example, the instruction may include a file name containing the custom-made attributes. Additionally or alternatively, the instruction may include information associated with the custom-made attributes such as the name of the client system with which the custom-made attributes are associated as well as the date of deployment of the custom-made attributes to the attribute processing agent 114. The attribute processing agent 114 can, in some embodiments, automatically invoke the file having the custom-made attributes.

The attribute processing agent 114 can receive the batch request and the set of data to be processed from the data processing system 112. The attribute processing agent 114 can also receive the set of attributes, which may include standardized as well as custom-made attributes, for data processing. The attribute processing agent 114 can simultaneously execute multiple requests for data processing using custom-made attributes. For example the requests may include one request for processing data in accordance with one set of custom-made attributes and another request for processing data in accordance with another set of custom-made attributes. The attribute processing agent 114 can batch process these two requests, for example, by issuing a first database query to process data in accordance with the first set of custom-made attributes as well as executing another database query in parallel for processing data in accordance with the another set of custom-made attributes. Each set of custom-made attributes may be invoked as part of the database query, for example, by invoking the name of the file having the set of custom-made attributes.

In some embodiments, the set of attributes may include a filter having one or more transformation rules. The filter can transform the input data from different sources into a common format. As an example, a REVOLVINGLOC filter can be defined on different data sources to transform each proprietary definition into a common True/False flag. This flag can then be used in other filters or attributes regardless of data source. In certain implementations, the set of data may be filtered so that the attribute processing agent may process a subset of the data according to the set of attributes. For example, a custom-made attribute may be consumers who opened a credit card account in the past month. The attribute processing agent 114 can identify a subset of consumers who opened the credit card account in the past month from a set of consumers in a data source. The attribute processing agent 114 can further analyze the data on the subset of consumers, such as identifying common demographic information among the subset of consumers.

After the attribute processing agent 114 processes the data, the attribute processing agent 114 can generate an output representing the results of the analysis. The attribute processing agent 114 can communicate the results to the decision system 116 for further processing. In some embodiments, the output may be written to a file and the attribute processing agent 114 can pass the file's name and location to the decision system 116.

The decision system 116 can receive the output from the attribute processing agent 114 and perform further processing. For example, the decision system 116 can receive a set of transaction data having certain attributes from the attribute processing agent 114. The decision system 116 can decide whether the transactions are fraudulent based on certain fraud detection factors such as whether the transactions use a false credit card or are associated with a geographical region that is associated with a high likelihood of fraud. The decision system 116 can output the decisions in batches. For example, the decision system 116 can output whether to accept or decline a set of transactions, or mark a set of transactions as fraudulent or safe. In some embodiments, the decision system 116 can generate an alert and communicate the alert to another computing device. For example, when the decision system 116 determines that a transaction is fraudulent, the decision system 116 can generate and transmit an alert to another computing device causing that computing device to decline or approve the transaction. In some implementations, the decision system 116 can generate a decision or an alert related to a transaction in real-time.

### Example Client System

The client system 120 may include components similar to the computing system 800, discussed below with reference to FIG. 8. In some embodiments, the client system 120 may be part of the financial institution's system. The client system 120 can include a data attribute management system 124 and a decision management system 126, where the data attribute management system 124 can be used to configure custom-made attributes and the decision management system 126 can be used to configure various rules implemented by the decision system 116.

For example, a bank may be interested in knowing the characteristics of the consumers who have opened credit cards in recent months at a certain bank branch. The bank may create custom-made attributes using the data attribute management system 124 incorporating these conditions. The data attribute management system 124 can communicate the custom-made attributes to the data analysis system 110. In some embodiments, the custom-made attributes may be deployed to become part of the attribute processing agent 114. For example, the attribute processing agent 114 may be an agent that is specific to the client system 120. Accordingly, the attribute processing agent 114 can automatically process data using the custom-made attributes designed by the client system 120.

In some embodiments, the client system 120 may periodically communicate updates of the custom-made attributes to the attribute processing agent 114. For example, the client system 120 can deploy a new set of custom-made attributes to the attribute processing agent 114 every few weeks. Modifications to a system/set of attributes can be made in the data attribute management system 124 and a deployment file can then be generated. The deployment file may be manually or automatically communicated to the attribute processing agent 114. In some implementations, the data attribute management system 124 may communicate a new deployment file to the attribute processing agent 114 setting forth the updated custom-made attributes. The attribute processing agent 114 can thereby invoke the new deployment file (instead of the old file having previous attributes) for future processing. Multiple versions of the attributes in a deployment file may coexist in the attribute processing agent 114 and be explicitly requested at execution time.

As another example, the decision management system 126 of the client system 120 can allow the bank (or another entity) to configure strategies used by the decision system 116 for data processing. The decision management system 126 can specify the weight of a certain factor in the decision making process. For example, the decision management system 126 can specify a threshold income level used by decision system 116 for making a decision as to whether to grant a user a certain credit limit. The decision management system 126 can also specify factors (such as, for example, an IP address of a consumer, a geographical location of the consumer, and so on) as well as their associated weight used in the fraud detection process.

The decision management system 126 can communicate an update of the strategies to the decision system 116. For example, the decision management system 126 can change the factors used in the decision making process or adjust the relative weights of the factors. Once the decision management system 126 communicates the update to the decision system 116, the decision system 116 can update its rules to incorporate the updated information from the decision management system 126.

### Example Communications between a Client System and a Data Analysis System

FIGS. 2A and 2B illustrate example communications between a client system and a data analysis system. In the computing environments 200a and 200b, the client system 220 can communicate with data analysis system 210a for batch processing of data based on custom-made attributes. The client system 220 may be an embodiment of the client system 120 and the data analysis system 210a may be an embodiment of the data analysis system 110 shown in FIG. 1.

In FIG. 2A, the client system 220 can communicate custom-made attributes to the data analysis system 210a at step 1. In this example, the client system 220 may be a financial institution and the data analysis system 210a may be a credit bureau. The financial institution can create a set of custom-made attributes and communicate the custom-made attributes to the credit bureau so that the credit bureau can process the credit data based on the financial institution's criteria.

The data analysis system 210a can receive a request to batch process a set of data from the client system 220. The batch request may include the set of custom-made attributes and a set of data that needs to be processed (such as, for example, a set of transactions, a set of consumer credit data, and so on). The data analysis system 210a can also receive multiple requests each associated with a different set of custom-made attributes and batch process such requests. In some embodiments, the data analysis system 210a can receive both the custom data attributes and the request from the client system 220 at step 1. Though not illustrated in FIG. 2A, the client system may also communicate the same custom-made attributes to other data analysis systems (such as other credit bureaus) that each implement their own instance of an attribute processing agent.

The data analysis system 210a can communicate with the data store 250a to retrieve data at step 2. As described with reference to FIG. 1, the data processing system 112 may be configured for data retrieval. For example, the data processing system 112 can run a database query to select a set of data for processing. The data processing system 112 (or a component of the attribute processing agent) can also identify a set of data presented to a calculation engine for each agent call.

At step 3, the data analysis system 210a can batch process the data using the custom data attributes. For example, the data analysis system 210a can invoke one or more attribute processing agent(s) to process the retrieved data using the custom data attributes. The decision system 116 of the client system 210a can further make decisions on the results processed by the attribute processing agent 114. In some embodiments, step 2 and step 3 may be combined. For example, the data analysis system 210a may include an attribute processing agent that is part of the data store 250a. To process data using custom-made attributes, the attribute processing agent may be interfaced with the database. For example, the attribute processing agent may be automatically invoked in a database query. The attribute processing agent may be either embedded into the database system or interfaced with the database system. One or more deployment files may be installed into the attribute processing agent. The database query may include a selected set of data as well as one or more function calls to the attribute processing agent. When the database query is executed, a selected set of data can be input into the attribute processing agent and the attribute processing agent can process the data using a set of attributes.

At step 4, the data analysis system 210a can return results of the batch process to the client system 220. The results may include the set of data retrieved from the data store 250a. Additionally or alternatively, the results may include decisions on the set of data. Once the client system 220 receives the results, the client system 220 may perform further data processing. For example, the client system 220 may use custom-made attributes to retrieve from the data analysis system 210a a set of people who may be potentially interested in opening a credit card account. The client system 220 can perform further analysis on the set of people to pre-approve a group of people for a credit card.

FIG. 2B illustrates another example communication between a data analysis system and a client system. The computing environment 200b includes a data analysis system provider 230, a data vendor 240, and a client system 220. The data analysis system provider 230 can develop one or more components of the data analysis system 210b, such as the attribute processing agent. At step 1, the data analysis system provider 230 can provide the one or more components of the data analysis system 210b, such as the attribute processing agent, to the data vendor 240. As an example, the data analysis system provider 230 can compile the data attribute processing agent into an executable file and communicate the executable file to the data vendor 240 for integration and deployment.

The data vendor 240 may be a credit bureau or other provider of data services with respect to consumers or businesses. The data vendor 240 can perform various data analysis using the data analysis system 210b and its data store 250b. In some embodiments, one or more components of the data analysis system 210b may be part of the data store 250b. For example, an attribute processing agent 114 (shown in FIG. 1) may directly interface with the data store 250 so that the data in the data store 250b may not have to be converted to another format before being processed by the attribute processing agent.

The client system 220 may be a financial institution as described with reference to FIG. 2A. The client system 220 can customize data attributes and communicate such data attributes to data vendor 240 at step 2.

The data vendor 240 can store the customized data attributes at the data store 250b or in another data store associated with the data analysis system 210b. The data vendor 240 can receive a request to batch process a set of data. The request may come from the client system 220, from the data vendor 240, or from another computing system not shown in FIG. 2B.

In response to the request, at step 3, the data analysis system 210b can retrieve the data from the data store 250b. For example, a data processing system of the data analysis system 210b can retrieve credit data from a credit bureau's database. The data analysis system 210b can process the data using the custom-made attributes. For example, the data analysis system 210b can input the data set as well as the set of custom-made attributes into the attribute processing agent 114 (described in FIG. 1) for processing.

At step 4, the data vendor 240 can return the results of the processed data to the client system 220 if the request for batch processing comes from the client system 220. If the request is from another system, the data vendor 240 can accordingly return the results to that system. The results may be returned in a batch or as they are generated by the data analysis system 210b.

### Example of Data Analysis Using Attributes

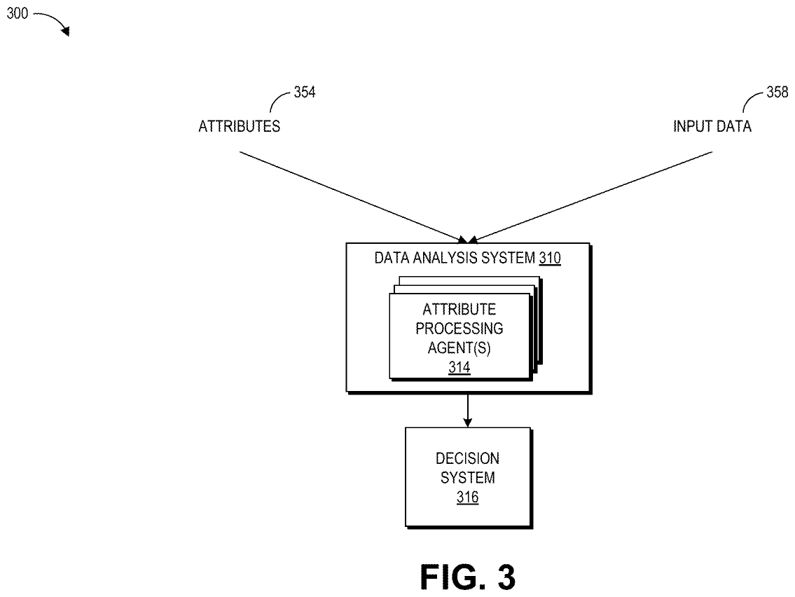

FIG. 3 illustrates an example of analyzing data using one or more attributes. The computing environment can include a data analysis system 310 (which may include one or more attribute processing agent(s)) and a decision system 316. The data analysis system 310 may be an embodiment of the data analysis system 110 shown in FIG. 1, while the attribute processing agent(s) 314 may be embodiments of the attribute processing agent(s) 114 in FIG. 1. In the computing environment 300, the data analysis system 310 can receive attributes 354 and input data 358. The attributes may include custom-made attributes created by a client system. The input data 358 may include credit data and/or transaction data for one or more consumers. In some embodiments, the data analysis system 310 may receive a request to process a set of data using the custom attributes. A data processing system of the data analysis system 310 may communicate with a data store, such as the data store of a credit bureau, to retrieve the credit data.

As described with reference to FIGS. 1 and 2B, at least a portion of the data analysis system 310 (such as one or more attribute processing agent(s) 314) may be embedded in the credit bureau's database or be part of the credit bureau's database system. As a result, the data analysis system 310 may not need to access the input data 358 from a remote location.

The data analysis system 310 can receive at least a portion of the attributes 354 from a client system (such as, for example, a bank or other lender). For example, the data analysis system 310 may receive a set of custom-made attributes from the client system while retrieving a set of standardized attributes from the credit bureau's system.

The data analysis system 310 can batch process the input data 358 using the custom-made attributes 354 with one or more attribute processing agent(s) 314. For example, the data analysis system 310 can invoke one or more attribute processing agent(s) 314 and input the custom attributes and credit data into the one or more attribute processing agent(s) 314. The attribute processing agent(s) 314 may be distributed among multiple computing nodes. For example, the attribute processing agent(s) 314 may be implemented in a Hadoop file system (HDFS) where each worker node in the Hadoop system may be associated with one (or more) attribute processing agent. In some embodiments, each processing agent of a computing node may be configured to process the data stored on the computing node.

The attribute processing agent(s) 314 may be part of a single computing system. Each attribute processing agent may be in charge of processing a portion of the batch request. For example, an attribute processing agent may be dedicated to process data using a certain set of custom-made attributes. As an example, one attribute processing agent may be configured to process only the custom-made attributes from a certain financial institution. An attribute processing agent may also be part of a database. As a result, where the input data 358 involve data from multiple databases, the attribute processing agent for each database may be in charge of processing the data in the respective database.

In some embodiments, the attribute processing agent(s) 314 may be invoked from a database query. For example, the database query may make a function call to an attribute processing agent and input the set of data as well as the set of attributes to the attribute processing agent.

The data analysis system 310 can output data processed by the attribute processing agent(s) 314 to the decision system 316. The decision system 316 may further process the data based on strategies provided by a client system. For example, the decision system 316 can determine whether to increase the credit limit for a group of people by analyzing the results of the data analysis system 310. The decision system 316 as shown in FIG. 3 may be part of a client system, although in other embodiments, the decision system 316 may be part of the data analysis system 310 (such as, for example, the decision system 116 shown in FIG. 1).

### Example of Parallel Data Processing by Attribute Processing Agents

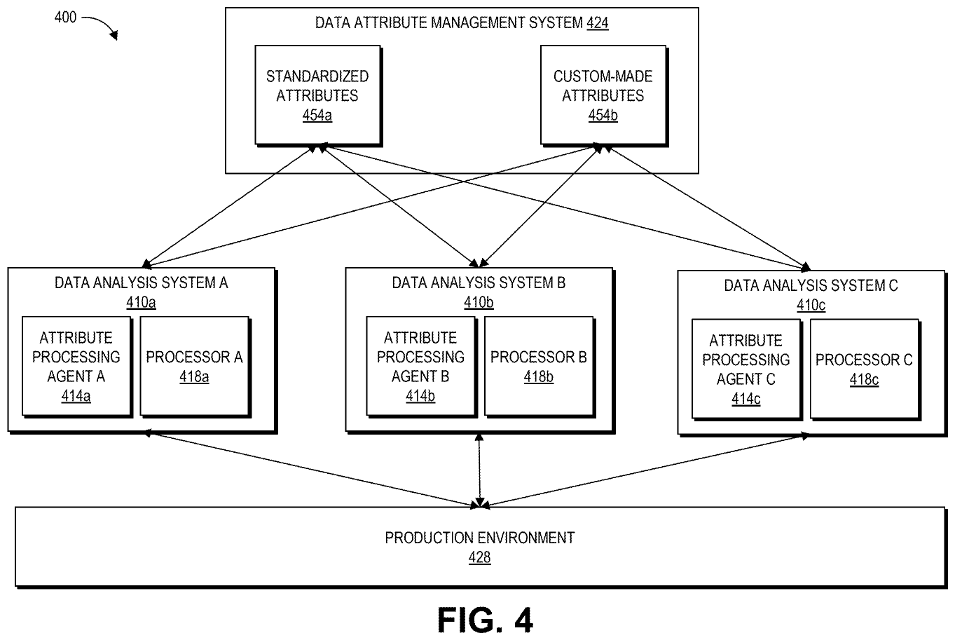

FIG. 4 illustrates an example of parallel data processing by a plurality of attribute processing agents. The computing environment includes a data attribute management system 424 (which may be an embodiment of the data attribute management system 124 of the client system 120 shown in FIG. 1), multiple data analysis systems 410a, 410b, and 410c, as well as a production environment 428. The production environment 428 may be part of the same client system as the data attribute management system 424. The production environment 428 may alternatively be associated with a separate entity than the data attribute management system 424.

As described with reference to FIG. 1, the data attribute management system 424 can generate and configure custom-made attributes 454b. Optionally, the data attribute management system 424 may configure standardized attributes 454a. For example, the data attribute management system 424 may be part of a credit bureau's system. The credit bureau may include its own standardized attributes 454a, as well as receive custom-made attributes from financial institutions. Advantageously, the credit bureau may not need to recode the received custom-made attributes. Rather, the credit bureau can communicate custom attributes 454b directly to the attribute processing agent an input. For example, the attribute processing agent may be configured to take an identifier of the set of custom-made attributes (such as the file name) as input for processing data assigned to the attribute processing agent.

The attributes can be communicated to one or more data analysis systems in the computing environment 400, such as the data analysis system A 410a, the data analysis system B 410b, and the data analysis system C 410c. Each data analysis system may be associated with different entities. For example, each data analysis system may be associated with a different credit bureau. A data analysis system may include a computer processor for processing data in accordance with the attributes. For example, the data analysis system A 410a may include the processor A 418a; the data analysis system B 410b may include the processor B 418b; and the data analysis system C 410c may include the processor C 418c. A data analysis system can also include one attribute processing agent. For example, the data analysis system A 410a may include the attribute processing agent A 414a; the data analysis system B 410b may include the attribute processing agent B 414b; the data analysis system C 410c may include the attribute processing agent C 414c.

In some embodiments, an attribute processing agent may be associated with a data store. The attribute processing agents A 414a, B 414b, and C 414c may each be associated with a data store of a credit bureau. For example, the attribute processing agents A 414a, B 414b, and C 414c may be embedded in the data store or be part of the database system of the credit bureau. Accordingly, an attribute processing agent can directly process the data in its associated data store. For example, an attribute processing agent may be invoked from the associated database, such as via a functional call. The attribute processing agent may also be specialized agents which only process a certain set of data. For example, an attribute agent may be specialized to process data of persons with last names starting with A through M, while another attribute agent may be assigned to process data of persons with last names starting with N through Z. The attribute processing agent may also be specialized to process a type of data.

Although in this example, only one attribute processing agent is shown per data analysis system, a data analysis system may include multiple attribute processing agents, where each attribute processing agent may be configured to process the data using a certain attribute or to process a certain set of data using a set of attributes.

The attribute processing agent A 414a, B 414b, and C 414c can output the results of the data analysis to the production environment 428. The attribute processing agents can be configured to process data in batches and output results in batches. The production environment 428 may receive the results from multiple attribute processing agents and combine the results for presentation to a user. For example, the production environment 428 may generate a user interface with credit scores from three credit bureaus, where each is associated with a data analysis system.

In some embodiments, the attributes may be written in a different programming language from the rest of systems in the computing environment 400. For example, the attributes may be written in Lua scripts while the production environment 428 may be written in Java. The Lua scripts may be compiled into Java bytecode for execution at run-time which can allow the functions in the production environment to easily invoke the attribute processing agent. Alternatively, the attribute processing agent can interpret the attribute definitions at runtime. In another option, the attribute agent could compile the attribute definitions upon run-time initialization into the target object code.

### Examples of an Attribute Processing Agent

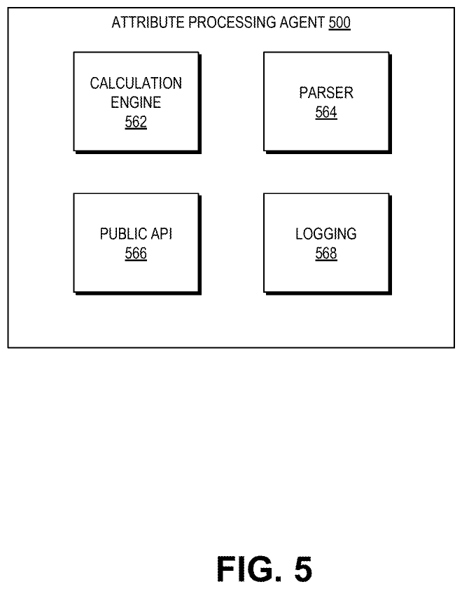

FIG. 5 illustrates an example of an attribute processing agent. The attribute processing agent 500 may be an embodiment of the attribute processing agent 114, 314, 414a, 414b, or 414c. The attribute processing agent 500 may be embedded in another system, such as a data analysis system or a database. The attribute processing agent 500 can receive a set of data and a set of attributes for processing and can output the results to another system. The attribute processing agent 500 may be configured for batch processing data associated with multiple transactions or entities. In some embodiments, the attribute processing agent 500 may be a set of Java Archive (JAR) files, configuration file(s), and/or files associated with deployments. According to some embodiments, there may be two options for deploying the attribute processing agent 500. In one option of the deployment, the attribute processing agent 500 and/or the attributes may be compiled (such as into a JAR format), interpreted, or compiled upon initialization, alone or in combination. In another option, the attribute processing agent may use existing interfaces to communicate with other systems.

The attribute processing agent 500 can include a calculation engine 562 which performs computations on the input data (see example input data 358 in FIG. 3), a parser 564 which can be configured to parse the input data, a public API 566 which can interface with other computing system(s) (such as a database in which the attribute processing agent 500 resides), and a logging module 568 which may log errors as well as information associated with invocations of the attribute processing agent 500. The attribute process agent 500 shown in FIG. 5 serves as an example attribute processing agent described herein. One or more systems or modules may be added to or removed from the attribute processing agent 500 in various embodiments.

The calculation engine 562 is configured to receive data, such as credit data, from a data processing system or the parser 564. The calculation engine 562 can perform calculations on the data in accordance to the attributes. For example, the calculation engine 562 can calculate the credit scores associated with a group of individuals over the past 6 months. In certain embodiments, the attributes can be deployed to the data processing system and the calculation engine 562 can retrieve the attributes from the data processing system.

The parser 564 can read and parse data. For example, the parser 564 may receive a set of input data from a database. The parser 564 may identify the values for each field of the input data set. In some embodiments, the input data may not entirely match the data required for processing by the calculation engine 562. The parser 564 may transform the input data into the format required by the calculation engine 562. For example, during a batch process for a set of transactions, the parser 564 can parse the transactions in parallel or one by one and feed the parsed data to the calculation engine 562. As another example, the parser 564 can parse the input data in real-time as data is being sent to the attribute processing agent 500. As another example, the parser 564 may automatically generate a database query based on the attribute. For example the generated database query may be based on a query, filter or function that is referred to in the attribute, and may be generated by the parser to be in an appropriate form for the given input data.

The attribute processing agent 500 can also include a public API 566. The public API 566 can be interfaced with another system such as db2 or other types of databases allowing the calculation engine 562 to be invoked from the other system. The public API 566 may be able to interface one type of programming environment with another type of programming environment. For example, the public API 566 may allow already parsed data to be sent directly to the calculation engine to bypass any parsing. The API 566 may also be used to indicate the system of attributes to calculate, the version, the type of input with other options possible.

In some embodiments, the attribute processing agent 500 can also include one or more logging modules 568. The logging modules can record errors when the attribute processing agent 500 is invoked or executed. For example, the errors may include java exceptions, encountered and thrown. Logging modules can also support logging to a central log file which includes various concurrent invocations of the attribute processing agent 500. The log files may be automatically archived. In some embodiments, due to the high number of requests processed by the attribute processing agent 500 as well as the large amount of data, the log files may be compressed. Logging modules can also support an in-memory option to ensure operational throughput is high and the persistence can then be offloaded to the calling system.

### Example Process of Batch Processing Custom-Made Attributes

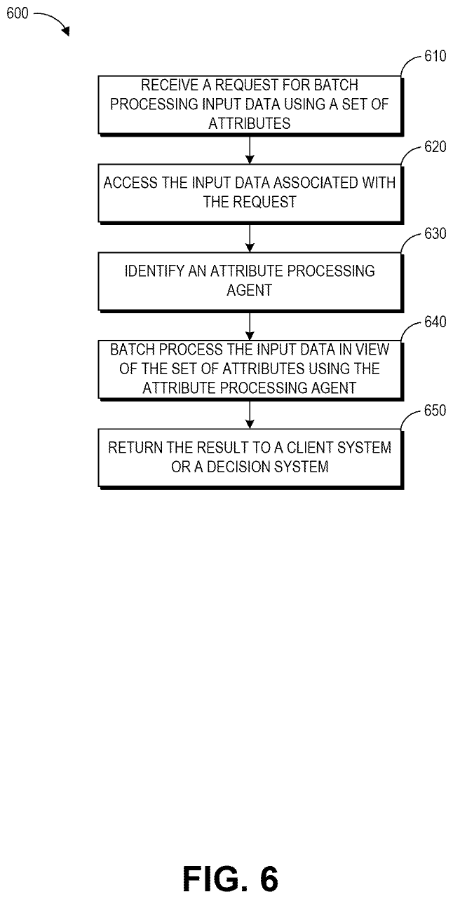

FIG. 6 a flow diagram depicting an illustrative method of batch processing input data using a set of attributes. The process 600 may be performed by the data analysis system 110, 210a, 210b, 310, 410a, 410b, and/or 410c. In some embodiments, the process 600 may be performed by a computing system (e.g. computing system 800) related to a credit bureau or a financial institution.

At block 610, the data analysis system receives a request for batch processing input data using a set of attributes. The set of attributes may include custom-made attributes configured by a client system or standardized attributes associated with a data analysis system. The request may specify a data set and/or the attributes to be analyzed. For example, a request may be provided to the data analysis system to determine results for a one or more attributes that are provided to the data analysis system in conjunction with the request. Alternatively, the request may be an indication to start a batch process that causes the data analysis system to retrieve attribute definitions that have been previously stored in a designated memory location, folder or directory for batch processing.

At block 620, the data analysis system can access input data associated with the request. For example, the data analysis system can retrieve the data using the set of attributes or the data set specified in the request. As an example, the set of attributes may include processing data associated with average monthly spending of one or more consumers. The data analysis system can identify the data needed to be processed using the set of attributes. In this example, the data analysis system may communicate with a data store of a credit bureau to retrieve the consumers' monthly credit data and calculate the consumers' monthly spending using the retrieved credit data. In some embodiments, block 620 (accessing input data) may be performed subsequent to block 630 (identifying an attribute processing agent) discussed below, or blocks 620 and 630 may be consumed within the batch processing of block 640 discussed below.

At block 630, the data analysis system can identify an attribute processing agent. The attribute processing agent may be part of the database which stores the input data. As a result, a database query may include an indication for invoking the attribute processing agent, such as, for example, by calling the attribute processing agent and specifying the custom-made attributes as the input.

At block 640, the data analysis system can batch process the input data in view of the attributes using the attribute processing agent. In some embodiments, multiple attribute processing agents may be identified and executed in parallel. For example, each attribute processing agent may be instructed to process a subset of the input data or be specialized in processing data in accordance with a certain attribute. In some embodiments, the attribute processing agent may include implementations of functions, filters and/or queries that are referenced in a given attribute, where the implementation is tailored for the data format, code or scripting language, or other deployment environment factors of the data analysis system and/or the specific input data.

The attribute processing agent can output a result of the batch processing. At block 650, the attribute processing agent can return the result to the client system, a decision system, or another computing system which issued the request. The result may further be processed or be displayed to a user (such as a lender) for review.

### Example Process of Batch Processing Custom-Made Attributes in Distributed Computer Architecture

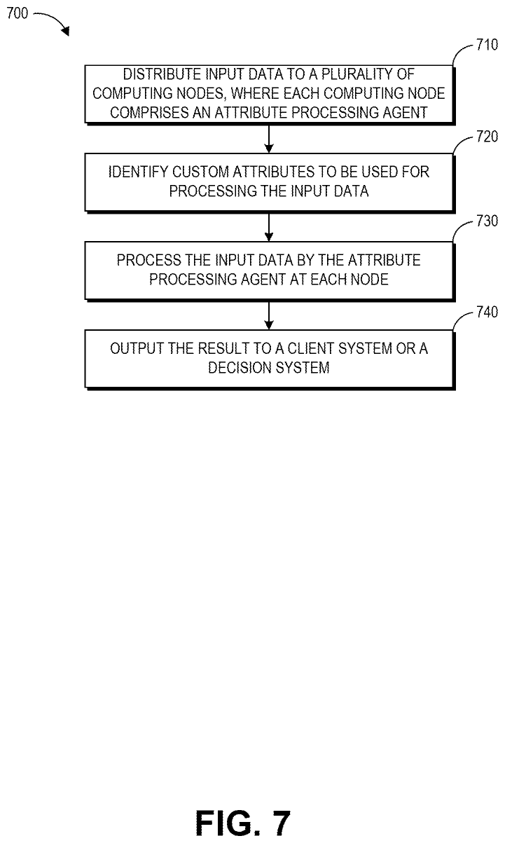

FIG. 7 is a flow diagram depicting an illustrative method of batch processing custom-made attributes in distributed computer architecture. The process 700 may be implemented using the data analysis system 110, 210a, 210b, 310, 410a, 410b, or 410c. For example, the data analysis system may include a plurality of computing systems 800 described with reference to FIG. 8. The process 700 may be performed by a computing system related to a credit bureau or a financial institution.

The data analysis system may receive a request to batch process a set of input data. At block 710, the data analysis system can distribute the input data to a plurality of computing nodes, where each computing node includes an attribute processing agent. For example, the input data may be processed utilizing an HDFS system. Each node in the HDFS system may have an attribute processing agent for processing the portion of the input data assigned to that node.

At block 720, the data analysis system can identify a set of custom-made attributes that will be used for processing the input data. The data analysis system can store the set of custom-made attributes on one or more nodes of the HDFS. The data analysis system can also store a portion of the custom-made attributes at one node while storing another portion of the custom-made attributes at a different node. The data analysis system may specify which custom-made attributes will be used for processing the input data.

At block 730, the attribute processing agent at each node can process the input data using the custom-made attributes. For example the attribute processing agent can use the assigned input data as well as the custom-made attributes as the input and run calculations on the input data.

At block 740, the attribute processing agent can output the result to a client system or a decision system, or another computing system. The result may further be processed or be displayed to a user (such as a lender) for review.

### Example System Implementation and Architecture

FIG. 8 illustrates a general architecture of a computing system for processing attributes and implementing various other aspects of the present disclosure. Many or all of the components of the computing system shown in FIG. 8 may be included in the various computing devices and systems discussed herein. The computing system may include, for example, a personal computer (such as, for example, IBM, Macintosh, Microsoft Windows compatible, OS X compatible, Linux/Unix compatible, or other types of computing systems, alone or in combination), a server, a workstation, a laptop computer, a smart phone, a smart watch, a personal digital assistant, a kiosk, a car console, a tablet, or a media player. In one embodiment, the computing system's processing system 800 includes one or more central processing units (“CPU”) 812, which may each include a conventional or proprietary microprocessor specially configured to perform, in whole or in part, one or more of the features described above. The processing system 800 further includes one or more memory 818, such as random access memory (“RAM”) for temporary storage of information, one or more read only memory (“ROM”) for permanent storage of information, and one or more mass storage device 803, such as a hard drive, diskette, solid state drive, or optical media storage device. A data store 821 may also be included. In some implementations, the data store 821 may be designed to handle large quantities of data and provide fast retrieval of the records. To facilitate efficient storage and retrieval, the data store 821 may be indexed using one or more of compressed data, identifiers, or other data, such as that described above.

Typically, the components of the processing system 800 are connected using a standards-based bus system 824. In different embodiments, the standards-based bus system 824 could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of processing system 800 may be combined into fewer components and modules or further separated into additional components and modules.

The processing system 800 is generally controlled and coordinated by operating system software, such as Windows XP, Windows Vista, Windows 7, Windows 8, Windows 10, Windows Server, Unix, Linux, SunOS, Solaris, iOS, MAC OS X, Blackberry OS, Android, or other operating systems. In other embodiments, the processing system 800 may be controlled by a proprietary operating system. The operating system is configured to control and schedule computer processes for execution, perform memory management, provide file system, networking, I/O services, and provide a user interface, such as a graphical user interface (“GUI”), among other things. The GUI may include an application interface and/or a web-based interface including data fields for receiving input signals or providing electronic information and/or for providing information to the user in response to any received input signals. A GUI may be implemented in whole or in part using technologies such as HTML, Flash, Java, .net, web services, and RSS. In some implementations, a GUI may be included in a stand-alone client (for example, thick client, fat client) configured to communicate (for example, send or receive data) in accordance with one or more of the aspects described.

The processing system 800 may include one or more commonly available input/output (“I/O”) devices and interfaces 815, such as a keyboard, stylus, touch screen, mouse, touchpad, and printer. In one embodiment, the I/O devices and interfaces 815 include one or more display devices, such as a monitor, that allows the visual presentation of data to a user. More particularly, a display device provides for the presentation of GUIs, application software data, and multimedia presentations, for example. The processing system 800 may also include one or more multimedia devices 806, such as speakers, video cards, graphics accelerators, and microphones, for example.

In the embodiment of FIG. 8, the I/O devices and interfaces 815 provide a communication interface to various external devices. The processing system 800 may be electronically coupled to one or more networks, which comprise one or more of a LAN, WAN, cellular network, satellite network, and/or the Internet, for example, via a wired, wireless, or combination of wired and wireless communication link. The networks communicate with various computing devices and/or other electronic devices via wired or wireless communication links.

In some embodiments, information may be provided to the processing system 800 over a network from one or more data sources. The data sources may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

In general, the word “module,” as used herein, refers to logic embodied in hardware or firmware, or to a collection of software instructions, possibly having entry and exit points, written in a programming language, such as, for example, Java, Lua, C, or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the processing system 800, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules. They may be represented in hardware or firmware. Generally, the modules described herein refer to logical modules that may be combined with other modules or divided into sub-modules despite their physical organization or storage.

In the example of FIG. 8, the modules 809 may be configured for execution by the CPU 812 to perform, in whole or in part, any or all of the process discussed above, such as those shown in FIGS. 1, 2A, 2B, 3, 4, 5, 6, and/or 7. The processes may also be performed by one or more virtual machines. For example, the processes may be hosted by a cloud computing system. In certain implementations, one or more components of the processing system 800 may be part of the cloud computing system. Additionally or alternatively, the virtualization may be achieved at the operating system level. For example, the one or more processes described herein may be executed using application containerization. The one or more processes may also be implemented on a Lambda architecture designed to handle mass quantities of data by taking advantage of the batch processing and the stream processing.

### Additional Embodiments

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated, via software code modules executed by a computing system that includes one or more computers or processors. In some embodiments, at least some of the processes may be implemented using virtualization techniques such as, for example, cloud computing, application containerization, or Lambda architecture, etc., alone or in combination. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a virtual machine, a processing unit or processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

1. (canceled)

2. A system for batch processing a data set that includes credit data of a plurality of consumers using a set of custom attributes, the system comprising:
a first computing node comprising one or more first processors, a first data store storing a first portion of the data set having a first format, and a first attribute processing agent comprising a calculation engine, a public application programming interface (API), and a first memory storing computer-executable code that, when executed by the one or more first processors, causes the first attribute processing agent to:
retrieve the first portion of the data set from the first data store; and
process, with the calculation engine, the first portion of the data set with the set of custom attributes, wherein the first attribute processing agent and the first data store are embedded in the first computing node so that the first portion of the data set in the first data store is processed without converting the first portion of the data set into a common format for processing;
a second computing node comprising one or more second processors, a second data store storing a second portion of the data set having a second format different from the first format, and a second attribute processing agent comprising the public API, and a second memory storing computer-executable code that, when executed by the one or more second processors, causes the second attribute processing agent to:
retrieve the second portion of the data set from the second data store;
invoke the calculation engine via the public API; and
process, with the calculation engine, the second portion of the data set using the set of custom attributes, wherein the second attribute processing agent and the second data store are embedded in the second computing node so that the second portion of the data set in the second data store is processed without converting the second portion of the data set into the common format for processing; and
a data analysis system comprising a third memory storing instructions and one or more hardware processors configured to execute the instructions to cause the one or more hardware processors to:
receive the set of custom attributes from a client system;
receive a request from the client system for batch processing the data set using the set of custom attributes;
parse the request to identify the data set and the set of custom attributes for batch processing;
in parallel, invoke the first attribute processing agent at the first computing node for batch processing the first portion of the data set using the set of custom attributes and invoke the second attribute processing agent at the second computing node for batch processing the second portion of the data set using the set of custom attributes;
receive results from the first attribute processing agent and the second attribute processing agent;
generate a response to the request based at least in part on the results from the first attribute processing agent and the second attribute processing agent;
generate a user interface that is configured to display the response; and
display, via the user interface, the response to the client system.

3. The system of claim 2, wherein the first computing node and the second computing node are part of a Hadoop file system.

4. The system of claim 2, wherein the custom attribute comprises a custom-made attribute created by the client system, and wherein the custom-made attribute comprises at least one of a computer executable function comprising one or more data filters, a database query, or computer code encoding a metric for analyzing the data set.

5. The system of claim 2, wherein the one or more hardware processors are further configured to:
generate an alert based on the results from the first attribute processing agent and the second attribute processing agent; and
communicate the alert to the client system causing the client system to approve or decline a transaction.

6. The system of claim 2, wherein to invoke the first attribute processing agent and to invoke the second attribute processing agent, the one or more hardware processors are configured to communicate the set of custom attributes to the first attribute processing agent and the second attribute processing agent as an input.

7. The system of claim 2, wherein to generate the response, the one or more hardware processors are configured to consolidate the results from the first attribute processing agent and the second attribute processing agent to generate a combined result.

8. A computer-implemented method for batch processing a data set that includes credit data of a plurality of consumers using a set of attributes, the method comprising:
under control of a database system comprising a data store and system memory that includes computer executable code that when executed by one or more processors of the database system causes the database system to:
receive a request from a client system for batch processing input data using the set of attributes;
identify a first attribute processing agent of a first computing node based at least in part on the input data and the set of attributes, wherein the first computing node comprises the first attribute processing agent and a first data store storing a first portion of the input data having a first format, wherein the first attribute processing agent comprises a calculation engine, a public application programming interface (API), and a first memory that includes computer-executable code, that when executed by one or more processors of the first computing node, causes the first attribute processing agent to process, with the calculation engine, the first portion of the input data with the set of custom attributes, wherein the first attribute processing agent and the first data store are embedded in the first computing node so that the first portion of the data set in the first data store is processed without converting the first portion of the input data into a common format;
identify a second attribute processing agent of a second computing node based at least in part on the input data and the set of custom attributes, wherein the second computing node comprises the second attribute processing agent and a second data store storing a second portion of the input data having a second format that is different from the first format, wherein the second attribute processing agent comprises the public API and a second memory that includes computer-executable code, that when executed by one or more processors of the second computing node, causes the second attribute processing agent to invoke the calculation engine via the public API, process, with the calculation engine, the second portion of the input data with the set of custom attributes, wherein the second attribute processing agent and the second data store are embedded in the second computing node so that the second portion of the data set in the second data store is processed without converting the second portion of the input data into the common format;
communicate, in parallel, the set of custom attributes to the first and second attribute processing agents as input;
receive a result of the batch processing of the first and second portions of the input data from the first and second attribute processing agents, respectively;
generate a response to the client system based at least in part on the result of the batch processing;
generate a user interface that is configured to display the response; and
display, via the user interface, the response to the client system.

9. The computer-implemented method of claim 8 further comprising receiving the set of custom attributes from the client system, wherein the set of custom attributes comprises custom-made attributes generated by the client system, and wherein each attribute of the set of custom attributes comprises computer code that can be interpreted or executed by any of a plurality of different attribute processing agents that are each configured for a different database system.

10. The computer-implemented method of claim 8, wherein the set of custom attributes comprises at least one of a computer executable function comprising one or more data filters, a database query, or computer code encoding a metric for analyzing the input data.

11. The computer-implemented method of claim 8, wherein identifying the first attribute processing agent based at least in part on the input data and the set of custom attributes comprises:
determining a storage location of the input data in the first computing node; and
identifying the first attribute processing agent based on the storage location of the input data, wherein the first attribute processing agent is configured to process the input data using the set of custom attributes at the storage location.

12. The computer-implemented method of claim 8, wherein communicating the set of custom attributes to the first attribute processing agent as the input comprises:
invoking the calculation engine of the first attribute processing agent; and
inputting the input data into the calculation engine for processing using the set of custom attributes.

13. The computer-implemented method of claim 8 further comprising:
generating an alert based at least in part on the result of the batch processing; and
communicating the alert to the client system causing the client system to approve or decline a transaction.

14. The computer-implemented method of claim 13 further comprising receiving a set of decision strategies from the client system, wherein the alert is generated based at least in part on the set of decision strategies.

15. The computer-implemented method of claim 8 further comprising receiving the first attribute processing agent as a set executable code from a data analysis system provider.

16. A data analysis system for batch processing a data set that includes credit data of a plurality of consumers using a set of custom attributes, the data analysis system comprising:
a data processing system comprising system memory that includes computer executable code that when executed by one or more processors of the data processing system causes the data processing system to:
receive a request from a client system for batch processing input data using the set of custom attributes;
identify, based at least in part on the input data and the set of custom attributes, a first attribute processing agent of a first computing node that is configured to process a first portion of the input data and a second attribute processing agent of a second computing node that is configured to process a second portion of the input data, wherein a first data store of the first computing node stores a first portion of input data and a second data store of the second computing node stores a second portion of the input data, the first portion having a first format and the second portion having a second format different from the first format, wherein the first attribute processing agent and the first data store are embedded in the first computing node and the second processing agent and the second data store are embedded in the second computing node to permit the first and second processing agents to process their corresponding portions of the input data without transforming formats of their corresponding portions of the input data into a common format during batch processing; and
invoke, in parallel, the first attribute processing agent at the first computing node and the second attribute processing agent at the second computing node to batch process the input data using the set of custom attributes, wherein the set of custom attributes are communicated to the first and second attribute processing agents as input;
wherein the first attribute processing agent comprises a calculation engine, a public application programming interface (API), and a first memory that includes computer-executable code that when executed by one or more processors of the first computing node causes the first computing node to:
access the set of custom attributes from the data processing system;
without transforming the first format of the first portion of the input data into the common format for processing, perform computation, with the calculation engine, on the first portion of the input data with the set of custom attributes;
generate a first result of the batch processing from the computation on the input data; and
communicate the first result to a decision system; and
wherein the second attribute processing agent comprises the public application programming interface (API), and a second memory that includes computer-executable code that when executed by one or more processors of the second computing node causes the second computing node to:
access the set of custom attributes from the data processing system;
without transforming the second format of the second portion of the input data into the common format for processing, invoke the calculation engine via the public API, perform computation, with the calculation engine, on the second portion of the input data with the set of custom attributes;
generate a second result of the batch processing from the computation on the input data; and
communicate the second result to the decision system;
the decision system configured to:
receive the first and second results of the batch processing from the first and second attribute processing agents;
generate a response to the client system based at least in part on the first and second results of the batch processing;
generate a user interface that is configured to display the response; and
display, via the user interface, the response to the client system.

17. The data analysis system of claim 16, wherein the set of custom attributes is received from the client system and the set of custom attributes comprises a custom-made attribute generated by the client system.

18. The data analysis system of claim 16, wherein the set of custom attributes comprises at least one of a computer executable function comprising one or more data filters, a database query, or a computer code encoding a metric for analyzing the data set.

19. The data analysis system of claim 16, wherein the data analysis system is further configured to:
receive the first attribute processing agent as a set of executable code from a data analysis system provider; and
embed the first attribute processing agent in the first computing node.

20. The data analysis system of claim 16, wherein the response comprises an alert causing the client system to halt or continue a transaction, wherein the alert is generated based at least in part on the first and second results of the batch processing.

21. The data analysis system of claim 20, wherein the decision system is further configured to receive a set of decision strategies from a decision management system, wherein the alert is generated based at least in part on the set of decision strategies.
